(19) United States
(12) Patent Application Publication
(10) Pub. No.: US 2009/0135210 A1
(43) Pub. Date: May 28, 2009

(54) VIDEO PROCESSING APPARATUS AND VIDEO PROCESSING METHOD

(75) Inventors: Cui FENG, Suwon-si (KR); Jong-sul MIN, Hwaseong-si (KR); Oh-jae KWON, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/257,810

(22) Filed: Oct. 24, 2008

(30) Foreign Application Priority Data
Nov. 28, 2007 (KR) 10-2007-0122227

(51) Int. Cl. G09G 5/10

(52) U.S. Cl. 345/690

(57) ABSTRACT

There are provided a video processing apparatus and a video processing method. The video processing apparatus includes: a video processing part which performs video processing to display a video on a display module which includes a plurality of light emitting devices corresponding to basic colors; and a controller which adjusts the luminous intensity of the light emitting devices on the basis of luminance change between an arbitrary pixel and a pixel adjacent to the arbitrary pixel so that a difference between light-remaining times of the light emitting devices is not larger than a predetermined value.

### CROSS-REFERENCE TO RELATED APPLICATION

This application claims priority from Korean Patent Application No. 10-2007-0122227, filed on Nov. 28, 2007 in the Korean Intellectual Property Office, the disclosure of which is incorporated herein by reference.

### BACKGROUND OF INVENTION

1. Field of Invention

Apparatuses and methods consistent with the present invention relate to a video processing apparatus and a video processing method which display a video on a display module including a plurality of light emitting devices.

2. Description of Related Art

In general, a video processing apparatus processes a video signal to display a video. The video processing apparatus may be connected to a display module for displaying the video. Recently, a display module such as an LCD, a PDP or a DLP is widely used. Particularly, the PDP can realize a large screen and a wide viewing angle, and has a relatively light weight and a relatively long durability.

Such a PDP and a conventional CRT display a video using the principle that a plurality of light emitting devices emits light beams corresponding to R (red), G (green) and B (blue) colors, electrons radiated at high voltage excite ultraviolet rays, and the excited ultraviolet rays are converted into visible rays by fluorescent material and then radiated. For this reason, there exists a light-remaining time in the PDP and CRT until the light emitting devices are completely turned off.

FIG. 1A shows light-remaining times for colors corresponding to the light emitting devices. As shown in FIG. 1A, the light-remaining time for the color B is the shortest; and that for the color G is the longest.

FIG. 1B illustrates afterimages perceived by human eyes. As shown in FIG. 1B, assuming that a particular object moves from a point C to a point A, if a video to be displayed has 60 frames every second, the frame is changed every 16.7 ms.

Here, human visual system characteristics cannot perceive the amount of light in the unit of a frame, but can perceive a continuous integral luminance. An afterimage remains in a position where an object has passed in such an integral luminance section.

Especially, in the case of a gray-scale-scale video, a green smear phenomenon that colors of yellow and green are displayed in a position where a white object has passed may be generated, which cause more inconvenience to a user.

### SUMMARY OF INVENTION

Accordingly, it is an aspect of the present invention to provide a video processing apparatus and a video processing method which can eliminate different colors of afterimages in the case that an object is displayed in a gray-scale-scale video.

Another aspect of the present invention is to provide a video processing apparatus and a video processing method which can exactly estimate an area where an afterimage should be eliminated, on the basis of change in the luminance of a pixel.

Still another aspect of the present invention is to provide a video processing apparatus and a video processing method which can correctly adjust the luminous intensity for eliminating an afterimage on the basis of change in the luminance of a pixel.

Additional aspects of the present invention will be set forth in part in the description which follows and, in part, will be obvious from the description, or may be learned by practice of the present invention.

The foregoing and/or other aspects of the present invention can be achieved by providing a video processing apparatus, including: a video processing part which performs video processing to display a video on a display module which includes a plurality of light emitting devices corresponding to basic colors; and a controller which adjusts the luminous intensity of the light emitting devices on the basis of luminance change between an arbitrary pixel and a pixel adjacent to the arbitrary pixel so that a difference between light-remaining times of the light emitting devices is not larger than a predetermined value.

The controller may calculate the luminance change on the basis of a motion vector of an object.

The controller may estimate an area in which the adjusting the luminous intensity is required on the basis of the luminance change, and control the video processing part to adjust the luminous intensity for the estimated area.

The controller may calculate the length in which pixels having a luminance level of a predetermined value or higher are continuous, and control the video processing part to adjust the luminous intensity corresponding to the calculated length.

The controller may calculate a ratio of pixels having a luminance level of a predetermined value or higher to pixels having a luminance level lower than the predetermined value, and control the video processing part to adjust the luminous intensity if the calculated ratio is not smaller than a predetermined value.

The controller may control the video processing part to increase the luminous intensity of the light emitting devices corresponding to colors R (red) and B (blue) among the plurality of light emitting devices.

The controller may control the video processing part to adjust the luminous intensity on the basis of a look-up map corresponding to the colors R and B.

The controller may control the video processing part to increase the luminous intensity by a ratio of the length in which pixels having a luminance level of a predetermined value or higher are continuous to the size of the motion vector of the object.

The video displayed on the display module may be a gray-scale-scale video.

The display module may include one of a PDP and a CRT.

The foregoing and/or other aspects of the present invention can be also achieved by providing a video processing method for displaying a video on a display module which includes a plurality of light emitting devices having different light-remaining times, the method including: calculating luminance change between an arbitrary pixel and a pixel adjacent to the arbitrary pixel; and adjusting the luminous intensity of the light emitting devices on the basis of the luminance change so that a difference between the light-remaining times is not larger than a predetermined value.

The luminance change may be calculated on the basis of a motion vector of an object.

An area in which the adjusting the luminous intensity is required may be estimated on the basis of the luminance change in the calculating the luminance change, and the luminous intensity may be adjusted for the estimated area in the adjusting the luminous intensity.

The length in which pixels having a luminance level of a predetermined value or higher are continuous may be calculated in the calculating the luminance change, and the luminous intensity may be adjusted corresponding to the calculated length in the adjusting the luminous intensity.

A ratio of pixels having a luminance level of a predetermined value or higher to pixels having a luminance level lower than the predetermined value may be calculated in the calculating the luminance change, and the luminous intensity may be adjusted if the calculated ratio is not smaller than a predetermined value.

The luminous intensity of the light emitting devices corresponding to colors R (red) and B (blue) among the plurality of light emitting devices may be adjusted in the adjusting the luminous intensity.

The luminous intensity may be adjusted on the basis of a look-up map corresponding to the colors R and B.

The luminous intensity may be increased by a ratio of the length in which pixels having a luminance level of a predetermined value or higher are continuous to the size of the motion vector, in the adjusting the luminous intensity.

The video displayed on the display module may be a gray-scale-scale video.

The display module may include one of a PDP and a CRT.

### BRIEF DESCRIPTION OF DRAWINGS

The above and/or other aspects of the present invention will become apparent and more readily appreciated from the following description of the exemplary embodiments, taken in conjunction with the accompanying drawings, in which:

FIGS. 1A and 1B illustrate light-remaining times for basic colors in a conventional video processing apparatus;

FIG. 2 is a block diagram illustrating a video processing apparatus according to an exemplary embodiment of the present invention;

FIG. 3 is a flowchart for illustrating a process of adjusting the luminous intensity of light emitting devices in the video processing apparatus in FIG. 2;

FIG. 4 illustrates a process of calculating a retrieval path for adjusting the luminous intensity in the video processing apparatus in FIG. 2;

FIG. 5 illustrates a process of estimating a green smear area along the retrieval path on the basis of luminance change of the present pixel in the video processing apparatus in FIG. 2;

FIG. 6 illustrates a process of obtaining a value LengthGS in the video processing apparatus in FIG. 2;

FIG. 7A illustrates a process of calculating a length LengthWHITE in which white pixels are continuously displayed;

FIG. 7B is a flowchart for illustrating a process of calculating the length in which pixels having a luminance level of a predetermined or higher are continuous;

FIG. 8 illustrates a process of calculating a ratio of black pixels to white pixels;

FIGS. 9 and 10 are flowcharts for illustrating a process of calculating a ratio RatioWB of black pixels to white pixels;

FIG. 11A illustrates a process of adjusting the luminous intensity of light emitting devices corresponding to basic colors; and

FIG. 11B is a flowchart for illustrating a process of adding a correction value to an intensity ratio of basic colors.

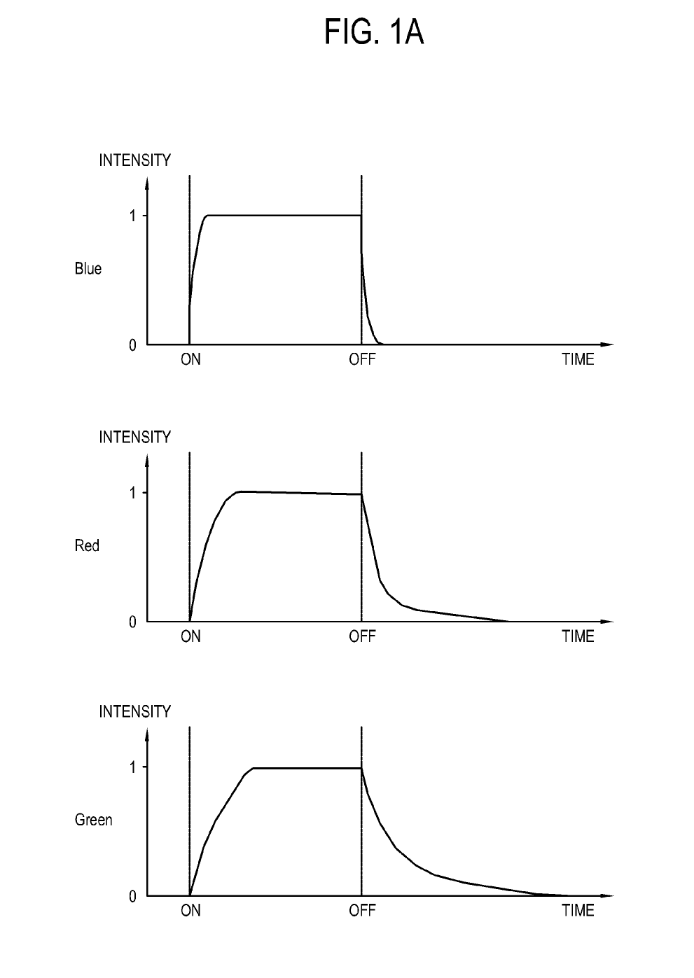

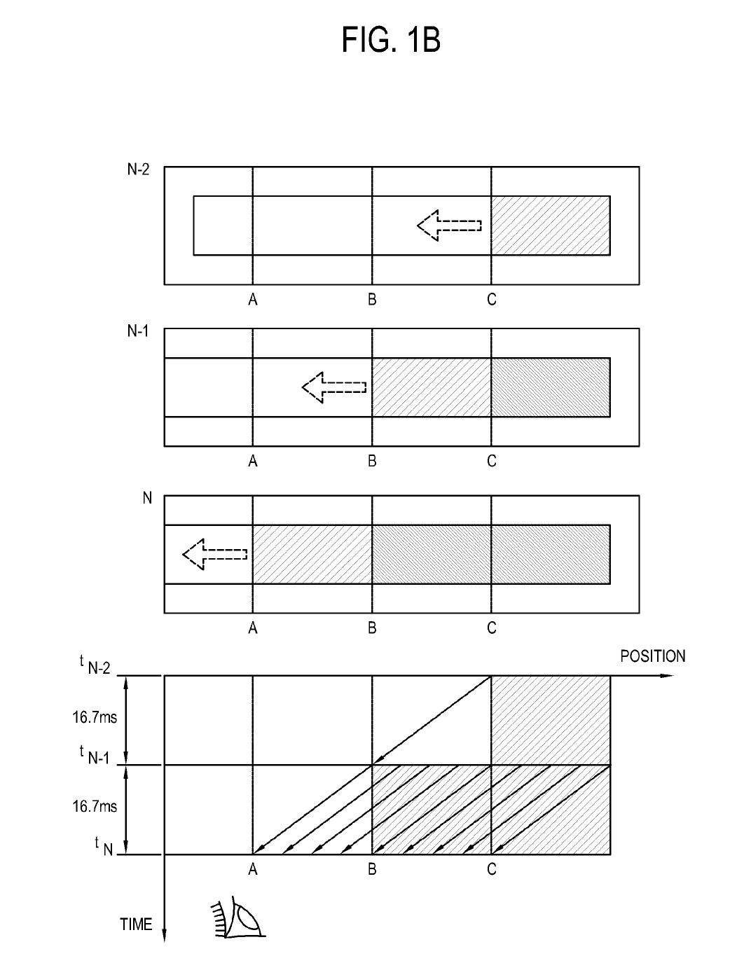

### DETAILED DESCRIPTION OF EXEMPLARY EMBODIMENTS

Reference will now be made in detail to the embodiments of the present invention, examples of which are illustrated in the accompanying drawings, wherein like reference numerals refer to like elements throughout. The exemplary embodiments are described below so as to explain the present invention by referring to the figures.

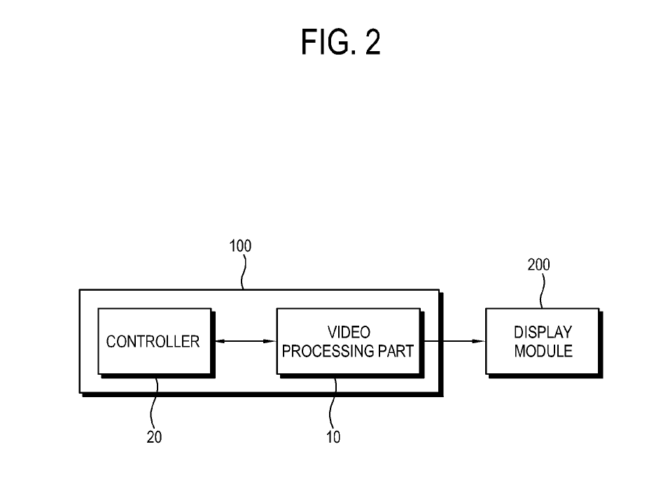

Referring to FIG. 2, a video processing apparatus 100 according to an exemplary embodiment of the present invention includes a video processing part 10 and a controller 20. The video processing apparatus 100 may be provided as a set top box which is separated from a display module 200 to be described later, or may be integrated with the display module 200 as a one body.

The video processing part 10 performs video processing to display a video on the display module 200 which includes a plurality of light emitting devices having different light-remaining times. Here, the plurality of light emitting devices may correspond to basic colors, for example, R, G and B colors. The display module 200 may be provided as a PDP or a CRT which displays a video using the principle that ultraviolet rays are converted into visible rays by fluorescent material and then radiated.

The video processing part 10 may include a motion correcting part therein. The motion correcting part compares the present frame with the preceding frame under the control of the controller 20 to estimate a motion vector. The motion correcting part divides the present frame into a plurality of blocks having a predetermined size, estimates a motion vector for a block whose motion is to be estimated among the present frame (hereinafter, referred to as ‘present block’), and then, performs motion correction according to the sum of absolute difference (SAD) for the estimated motion vector.

The video processing part 10 may perform the functions of decoding for extracting video information from a video signal, scaling for adjusting resolution of a decoded video according to a characteristic of the display module 200 and user's selection, picture enhancement for enhancing picture quality, etc.

The controller 20 adjusts the luminous intensity of the light emitting devices on the basis of luminance change between an arbitrary pixel and a pixel adjacent to the arbitrary pixel so that difference between light-remaining times of the light emitting devices included in the display module 200 is not larger than a predetermined value. In an exemplary embodiment, the controller 20 adjusts the luminous intensity of at least one of a light emitting device of first pixel and a light emitting device of a second pixel adjacent to the first pixel, based on the luminance change between the first pixel and the second pixel so that the difference between the light-remaining time of the light emitting device of the first pixel and the light-remaining time of the light emitting device of the second pixel is not larger than a predetermined value.

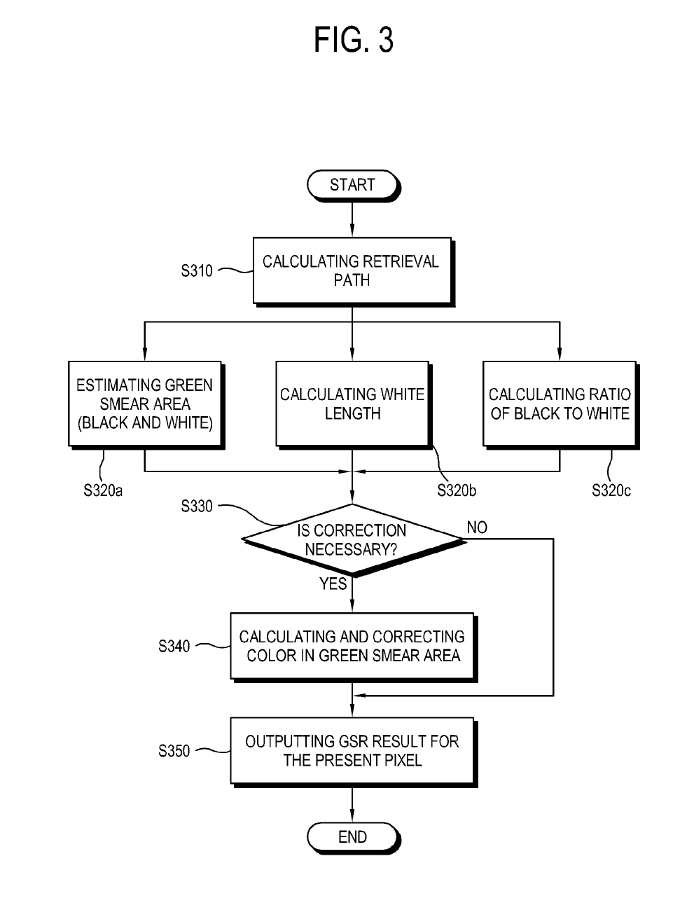

A process of adjusting the luminous intensity of the light emitting devices by the controller 20 will be described with reference to FIG. 3.

First, the controller 20 calculates a retrieval path for adjusting the luminous intensity (S310).

Then, the controller 20 estimates an area where the green smear phenomenon is generated and requires the adjustment of the luminous intensity (S320a), calculates the length that a white color is continuously displayed due to motion of an object (S320b), and calculates a ratio of black to white (S320c).

On the basis of the results of the operations S320a to S320c, the controller 20 determines whether or not the adjustment of the luminous intensity is necessary (S330).

If it is determined that the adjustment of the luminous intensity is necessary, the controller 20 calculates and corrects a color value necessary for the green smear area (S340).

Then, the controller 20 outputs the result of green smear reduction (GSR) for reducing the green smear for the present pixel (S350).

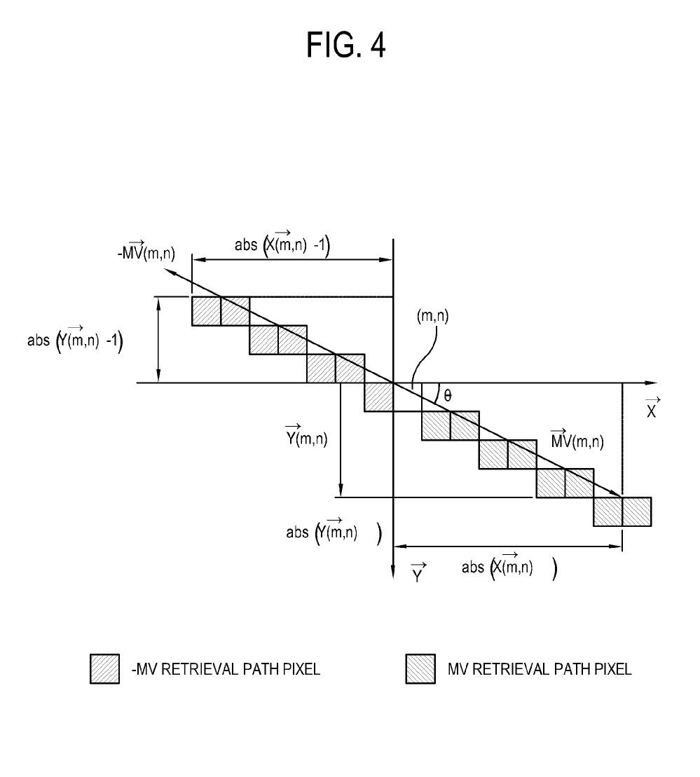

Hereinafter, the operation S310 for calculating the retrieval path to adjust the luminous intensity will be described with reference to FIG. 4.

The controller 20 retrieves a pixel of which luminous intensity is to be adjusted on the basis of an angle θ of a motion vector MV for the present pixel (m,n). As shown in FIG. 4, the controller 20 retrieves the pixel for a positive direction and a negative direction of the vector MV, respectively. Here, the length of the retrieval path is the same as the size of the motion vector MV in the positive direction, and is a value obtained by subtracting 1 from the size of the motion vector MV in the negative direction.

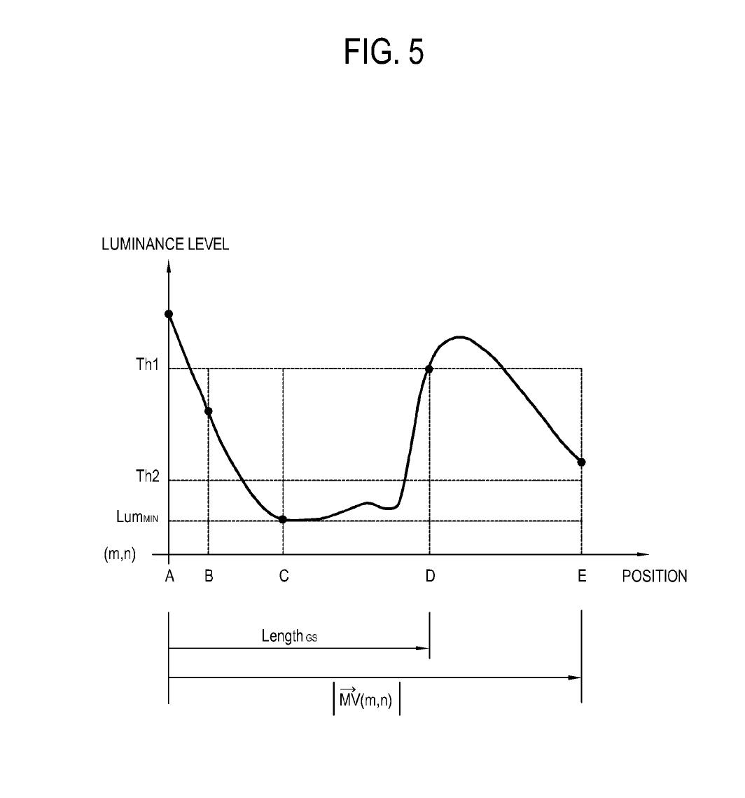

The controller 20 estimates the green smear area on the basis of the length retrieved at the operation S310. FIG. 5 shows a process of estimating the green smear area on the basis of change in the luminance of the present pixel along the path retrieved at the operation S310. As an object moves in the same direction as the motion vector, the luminance level of the present pixel changes. As shown in FIG. 5, the luminance level in a point A is higher than a threshold value Th1; the luminance level in a point B is lower than the threshold value Th1; and the luminance level in a point C is the minimum value LUMMIN which is lower than a threshold value Th2. Then, the luminance level increases and becomes the same as the threshold value Th1 in a point D. Here, the controller 20 sets a length from the point A in which the retrieval path starts to the point D in which the luminance level reaches the threshold value Th1 as LengthGS and estimates pixels corresponding to the set length LengthGS as the green smear area.

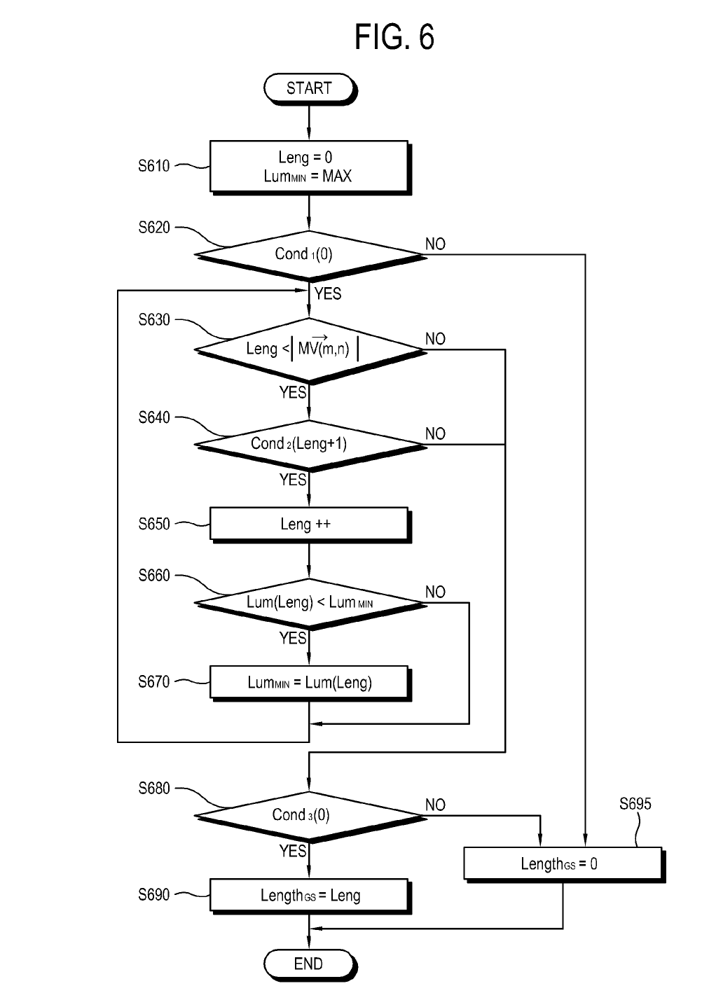

FIG. 6 is a flowchart for illustrating a process of obtaining the value LengthGS.

First, the controller 20 sets a variable Leng as 0, and sets the minimum luminance LUMMIN as an arbitrary maximum value MAX (S610).

Then, the controller 20 determines whether a value Cond1 at the pixel (0) in which the retrieval path starts is on or off (S620). Here, the value Cond1 is on in the case that the luminance level of the concerned pixel is not lower than the threshold value Th1, the luminance level of an adjacent pixel in the direction of the motion vector MV is lower than the threshold value Th1, and differences between R, G and B values at the concerned pixel are smaller than a threshold value Th3, that is, in the case of a gray-scale-scale video; and otherwise, off.

If the value Cond1 at the point in which the retrieval path starts is on, the controller 20 determines whether or not the value Leng is smaller than the size of the motion vector MV (S630).

If the value Leng is smaller than the size of the motion vector MV, the controller 20 determines whether a value Cond2 of a pixel in a position corresponding to a value obtained by adding 1 to the value Leng is on or off (S640). Here, the value Cond2 is on in the case that the luminance of the concerned pixel is lower than the threshold value Th1, the differences between the R, G and B values at the concerned pixel are smaller than the threshold value Th3, that is, in the case of the gray-scale-scale video; and otherwise, off

If the value Cond2 of the pixel in the position corresponding to the value obtained by adding 1 to the value Leng is on, the controller 20 increases the value Leng by 1 (S650).

Then, the controller 20 compares the luminance level of a pixel corresponding to the value Leng with the minimum luminance level LUMMIN (S660).

If the luminance level of the pixel corresponding to the value Leng is lower than the minimum luminance level LUMMIN, the controller 20 sets the luminance level of the pixel corresponding to the value Leng as the minimum luminance level (S670). Then, the process returns to the operation S630.

If the value Leng is not smaller than the size of the motion vector MV at the operation S630, or if the value Cond2 of the pixel in the position corresponding to the value obtained adding 1 to the value Leng at the operation S640 is off, the controller determines whether a value Cond3 of the starting pixel (0) is on or off (S680). Here, if the minimum luminance level is lower than the threshold value Th2, the value Cond3 is on; and otherwise, off

Then, if the value Cond3 is on, the controller 20 sets the value LengthGS as the value Leng (S690); and if the value Cond3 is off, the controller 20 sets the value LengthGS as 0 (S695). Also, the controller 20 sets the value LengthGS as 0, if the value Cond1 of the starting pixel (0) is off in the operation S620.

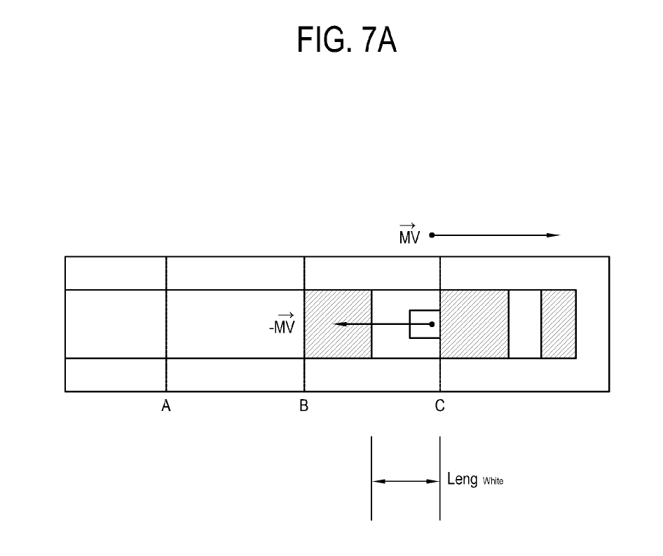

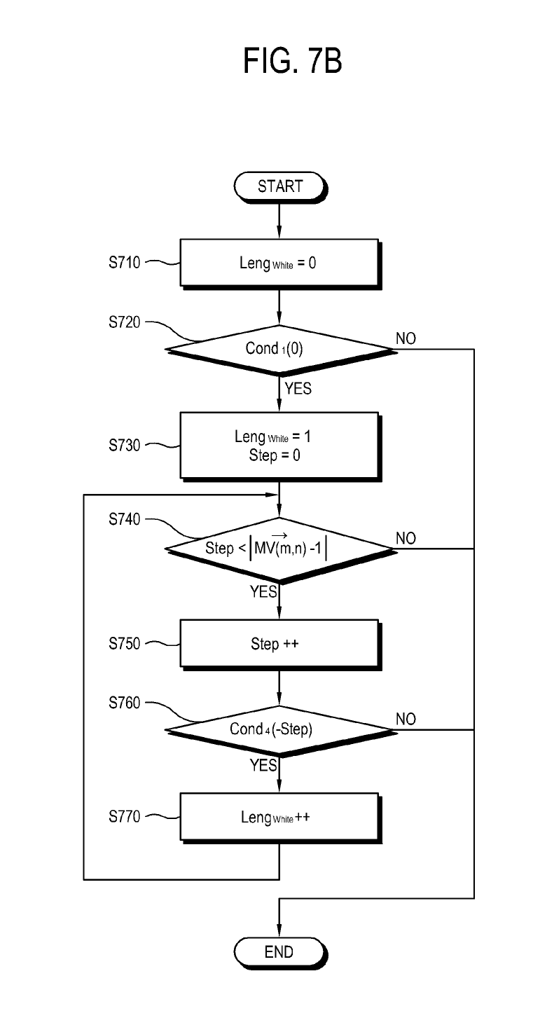

Then, if pixels corresponding to the set value LengthGS are estimated as the green smear area, the controller 20 calculates the length in which pixels having a luminance level of a predetermined value or higher are continuous. Here, it is desirable but not necessary to calculate the length in which white pixels are continuous due to motion of a white object. As shown in FIG. 7A, the length LengthWHITE in which the white pixels are continuous may be calculated by the size of the motion vector MV.

FIG. 7B is a flowchart for illustrating a process of calculating the length in which the pixels having the luminance level of the predetermined value or higher are continuous.

First, the controller 20 sets the value LengWHITE as 0 (S710).

Then, the controller 20 determines whether the value Cond1 at the point where the retrieval path starts is on or off (S720).

If the value Cond1 at the point where the retrieval path starts is on, the controller 20 sets the value LengWHITE as 1, and sets a value Step as 0 (S730).

Then, the controller 20 determines whether or not the value Step is smaller than a value obtained by subtracting 1 from the size of the motion vector MV (S740).

If the value Step is smaller than the value obtained by subtracting 1 from the size of the motion vector MV, the controller 20 increases the value Step by 1 (S750), and determines whether a value Cond4 corresponding to a value—Step is on or off (S760). Here, the value Cond4 is on in the case that the luminance level of the concerned pixel is not lower than the threshold value Th1, and differences between R, G and B values are smaller than the threshold value Th3; and otherwise, off.

If the value Cond4 corresponding to the value—Step is on, the controller increases the value LengWHITE by 1 (S770), and returns the process to the operation S740.

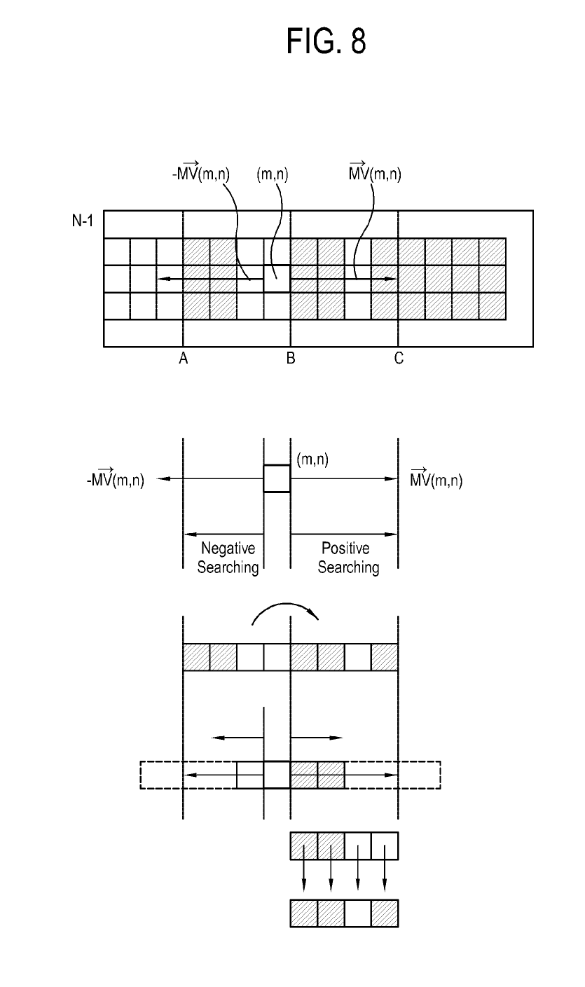

Hereinafter, a process of calculating the ratio of black pixels to white pixels will be described with reference to FIG. 8.

As shown in FIG. 8, the number of black pixels in the positive direction of the motion vector MV with respect to the (m,n) pixel is three, and the number of white pixels in the negative direction of the motion vector MV is two. According to motion of the object, the number of the black pixels changes into two from three in an area of the positive direction of the retrieval path of the (m,n) pixel.

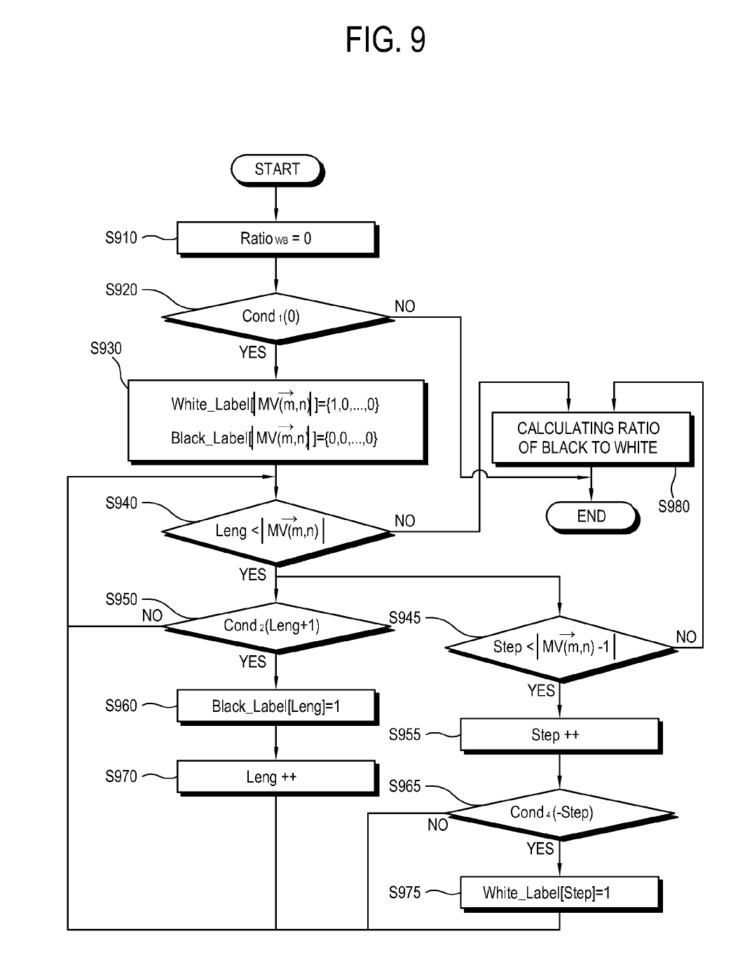

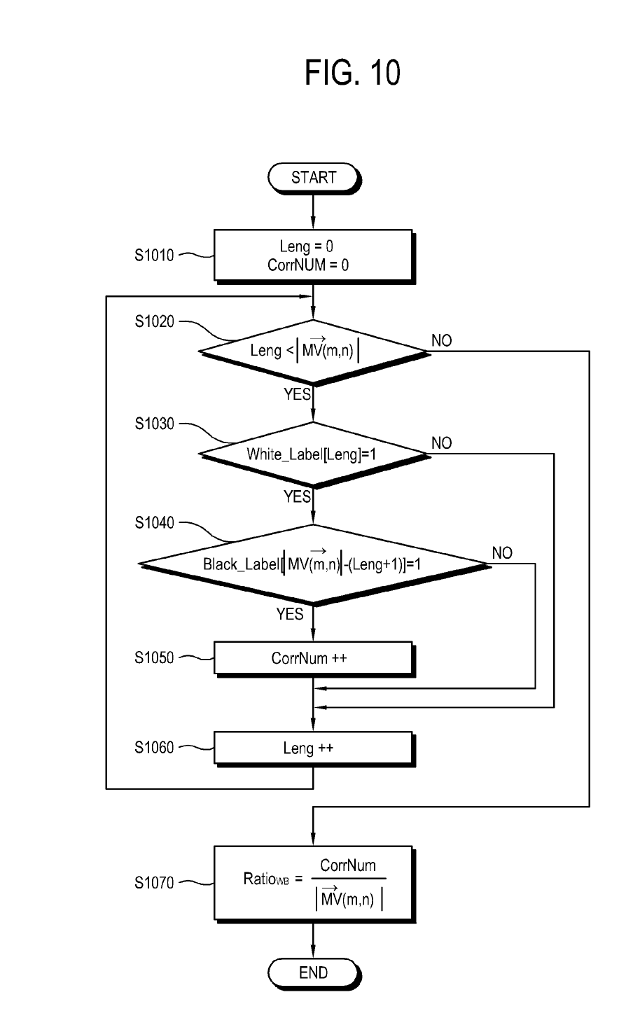

FIGS. 9 and 10 are flowcharts for illustrating a process of calculating a ratio RatioWB of black pixels to white pixels.

First, the controller 20 sets the ratio RatioWB as 0 (S910), and determines whether the value Cond1 corresponding to the starting pixel (0) is on or off (S920). As described above referring to FIG. 6, the value Cond1 is on in the case that the luminance level of the concerned pixel is not lower than the threshold value Th1, the luminance level of the adjacent pixel in the direction of the motion vector MV is lower than the threshold value Th1, and the differences between the R, G and B values at the concerned pixel are smaller than the threshold value Th3, that is, in the case of the gray-scale-scale video; and otherwise, off.

Then, if the value Cond1 for the starting pixel (0) is on, the controller 20 sets an arrangement WHITE_LABEL as {1,0, . . . ,0}, and sets an arrangement BLACK_LABEL as {0,0, . . . ,0} (S930).

Next, the controller determines whether or not the value Leng in FIG. 6 is smaller than the size of the motion vector MV (S940).

If the value Leng is smaller than the size of the motion vector MV, the controller 20 determines whether the value Cond2 of the pixel in the position corresponding to the value obtained by adding 1 to the value Leng is on or off (S950). Here, as described above referring to FIG. 6, the value Cond2 is on in the case that the luminance of the concerned pixel is lower than the threshold value Th1, the differences between the R, G and B values at the concerned pixel are smaller than the threshold value Th3, that is, in the case of the gray-scale-scale video; and otherwise, off.

If the value Cond2 is on, the controller 20 sets a value corresponding the value Leng among the arrangement BLACK_LABEL as 1 (S960), and increases the value Leng by 1 (S970). Then, the process returns to the operation S940.

Meanwhile, at the same time when performing the operation after the operation S940, the controller determines whether or not the value Step is smaller than a value obtained by subtracting 1 from the size of the motion vector MV (S945).

If the value Step is smaller than the value obtained by subtracting 1 from the size of the motion vector MV, the controller 20 increases the value Step by 1 (S955), and determines whether the value Cond4 corresponding to the value—Step is on or off (S965). Here, as described above referring to FIG. 7B, the value Cond4 is on in the case that the luminance level of the concerned pixel is not lower than the threshold value Th1, and the differences between the R, G and B values are smaller than the threshold value Th3; and otherwise, off.

If the value Cond4 is on, the controller 20 sets a value corresponding to the value Step among the arrangement WHITE_LABEL as 1 (S975). Then, the process returns to the operation S940.

If the value Leng is not smaller than the size of the motion vector MV at the operation S940, or if the value Step is not smaller than a value obtained by subtracting 1 from the size of the motion vector MV at the operation S945, the controller 20 calculates the ratio of black to white (S980).

Then, as shown in FIG. 10, the controller 20 sets the value Leng as 0, and sets a value CorrNUM as 0 (S1010).

Then, the controller determines whether or not the value Leng is smaller than the value of the motion vector MV (S1020).

If the value Leng is smaller than the value of the motion vector MV, the controller 20 determines whether or not a value corresponding to the value Leng among the arrangement WHITE_LABEL is 1 (S1030).

If the value corresponding to the value Leng among the arrangement WHITE_LABEL is 1, the controller 20 determines whether or not a value corresponding to a value obtained by subtracting a value Leng+1 from the value of the motion vector MV among the arrangement BLACK_LABEL is 1 (S1040).

If the value corresponding to the value obtained by subtracting the value Leng+1 from the value of the motion vector MV among the arrangement BLACK_LABEL is 1, the controller 20 increases the value CorrNUM by 1 (S1050), and increases the value Leng by 1 (S1060). Then, the process returns to the operation S1020.

If the value corresponding to the value Leng among the arrangement WHITE_LABEL is 0 at the operation S1030, or if the value corresponding to the value obtained by subtracting the value Leng+1 from the value of the motion vector MV among the arrangement BLACK_LABEL is 0 at the operation S1040, the controller 20 increases the value Leng by 1 (S1060), and returns the process to the operation S1020.

If the value Leng is not smaller than the value of the motion vector MV at the operation S1020, that is, if all the above processes are performed for all the pixels on the retrieval path, the controller 20 sets a value obtained by dividing the value CorrNUM by the value of the motion vector MV as the ratio RatioWB (S1070).

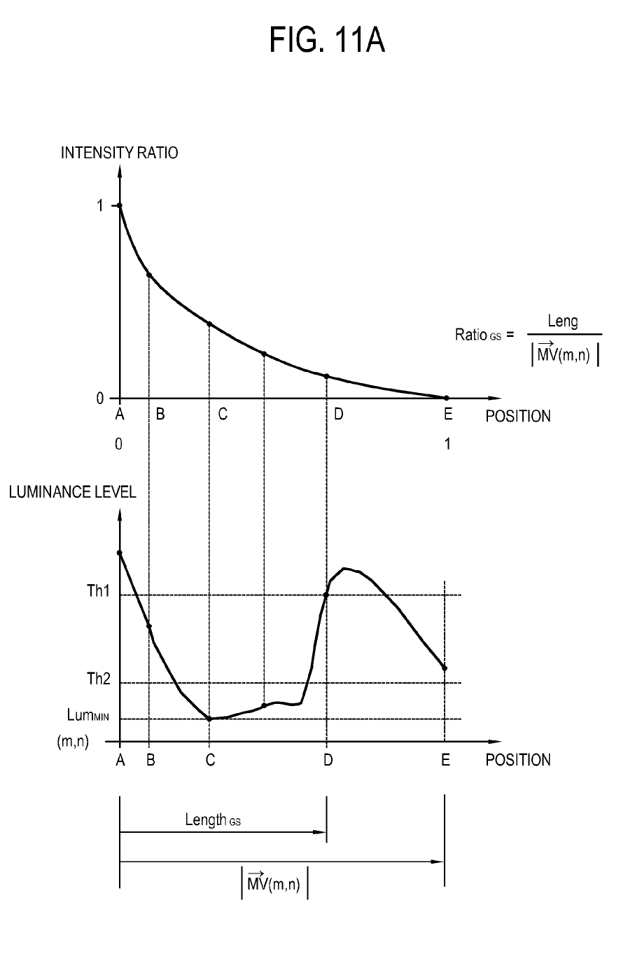

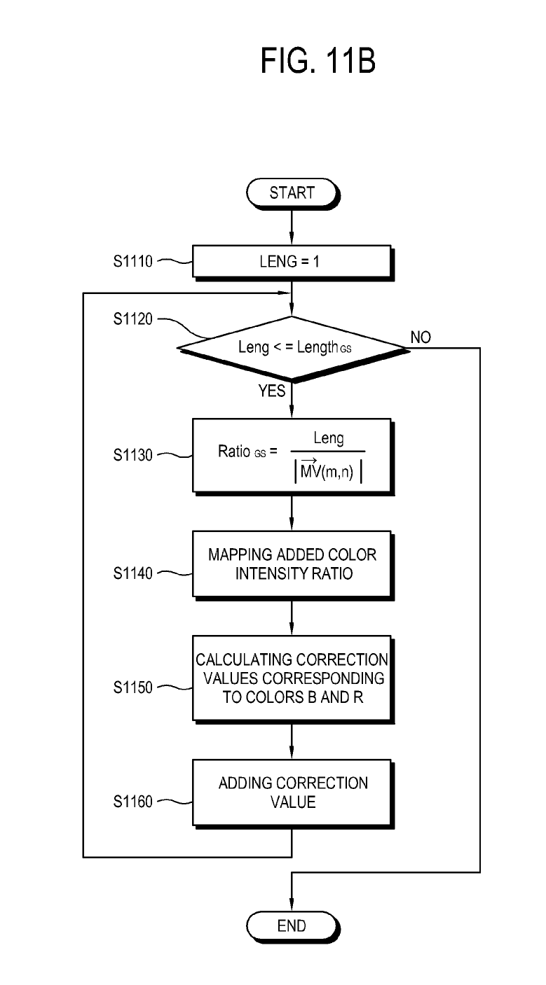

Hereinafter, a process of adjusting the luminous intensity of the light emitting devices corresponding to the basic colors will be described with reference to FIG. 11A, which illustrates a graph representing change in an intensity ratio according to change in a position and a graph representing change in the luminance level according to motion of an object, in the case that the light emitting device corresponding to the basic color B turns off

As shown in FIG. 11A, the intensity ratio is 1 at a point A, and decreases gradually according as the position changes to then become 0 at a point E. Such change in the intensity ratio is stored in a look-up map corresponding to the basic color, and a correction value for correcting the intensity ratio is determined for every position according to the change in the luminance level according to the motion of the object.

Here, the correction value is determined by a value RatioGS obtained by dividing the value Leng by the value of the motion vector MV. That is, the intensity ratio is much corrected in a position D where the luminance level is relatively high; and is little corrected in a position C where the luminance level is relatively low.

FIG. 11B is a flowchart for illustrating a process of adding the correction value to the intensity ratio of the basic color.

First, the controller 20 sets the value Leng as 1 (S1110).

Then, the controller 20 determines whether or not the value Leng is not larger than the value LengthGS (S1120).

If the value Leng is not larger than the value LengthGS, the controller 20 sets a value obtained by dividing the value Leng by the value of the motion vector MV as the value RatioGS (S1130).

Then, the controller 20 maps an added color intensity ratio on the basis of the look-up map corresponding to the basic color (S1140).

Then, the controller 20 calculates correction values corresponding to the colors B and R (S1150). The correction values are respectively calculated for the colors B and R by multiplying the intensity value corresponding to the color G in the point (0) where the retrieval path starts by the mapped value according to the value RatioGS and by a smaller one among 1 and a value obtained by adding a predetermined offset value to the value RatioWB.

Finally, the controller 20 adds the correction value calculated at the operation S1150 to the original intensity ratio. In this way, it is possible to make the light-remaining times of the colors R and B fit for the light-remaining time of the color G, thereby preventing the green smear phenomenon.

As described above, according to the present invention, in the case that a white object is displayed in a gray-scale-scale video, afterimages of different colors can be eliminated.

Further, an area in which afterimages are required to be eliminated can be exactly estimated on the basis of change in the luminance of a pixel.

Furthermore, the luminous intensity necessary for eliminating afterimages can be correctly adjusted on the basis of change in the luminance of a pixel.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A video processing apparatus, comprising:
a video processing part which performs video processing to display a video on a display module which comprises a plurality of light emitting devices corresponding to basic colors; and
a controller which adjusts at least one of a luminous intensity of a light emitting device of a first pixel and a luminous intensity of a light emitting device of a second pixel adjacent to the first pixel, based on a luminance change between the first pixel and the second pixel so that a difference between light-remaining times of the light emitting devices of the first and the second pixels is not larger than a predetermined value.

2. The video processing apparatus according to claim 1, wherein the controller calculates the luminance change based on a motion vector of an object.

3. The video processing apparatus according to claim 2, wherein the controller estimates an area in which the controller adjusts the at least one of the luminous intensities, based on the luminance change, and controls the video processing part to adjust the at least one of the luminous intensities for the estimated area.

4. The video processing apparatus according to claim 2, wherein the controller calculates a length in which pixels having a luminance level of a predetermined value or higher are continuous, and controls the video processing part to adjust the at least one of the luminous intensities based on the calculated length.

5. The video processing apparatus according to claim 2, wherein the controller calculates a ratio of pixels having a luminance level of a predetermined value or higher to pixels having a luminance level lower than the predetermined value, and controls the video processing part to adjust the at least one of the luminous intensities if the calculated ratio is not smaller than a predetermined ratio.

6. The video processing apparatus according to claim 3, wherein the controller controls the video processing part to increase luminous intensities of the light emitting devices corresponding to colors red (R) and blue (B) among the plurality of light emitting devices.

7. The video processing apparatus according to claim 6, wherein the controller controls the video processing part to adjust the at least one of the luminous intensities based on a look-up map corresponding to the colors R and B.

8. The video processing apparatus according to claim 7, wherein the controller controls the video processing part to increase the at least one of the luminous intensities by a ratio of the length in which pixels having a luminance level of a predetermined value or higher are continuous, to a size of the motion vector of the object.

9. The video processing apparatus according to claim 1, wherein the video displayed on the display module is a gray-scale-scale video.

10. The video processing apparatus according to claim 1, wherein the display module comprises one of a PDP and a CRT.

11. A video processing method for displaying a video on a display module which comprises a plurality of light emitting devices having different light remaining times, comprising:
calculating a luminance change between a first pixel and a second pixel adjacent to the first pixel; and
adjusting at least one of a luminous intensity of a light emitting device of the first pixel and a luminous intensity of a light emitting device of the second pixel, based on the luminance change so that a difference between light-remaining times of the light emitting devices of the first and the second pixels is not larger than a predetermined value.

12. The video processing method according to claim 11, wherein the luminance change is calculated based on a motion vector of an object.

13. The video processing method according to claim 12, wherein an area in which the adjusting the at least one of the the luminous intensities is required, is estimated based on the luminance change in the calculating the luminance change, and the at least one of the luminous intensities is adjusted for the estimated area in the adjusting the at least one of the luminous intensities.

14. The video processing method according to claim 12, wherein a length in which pixels having a luminance level of a predetermined value or higher are continuous, is calculated in the calculating the luminance change, and the at least one of the luminous intensities is adjusted based on the calculated length in the adjusting the at least one of the luminous intensities.

15. The video processing method according to claim 12, wherein a ratio of pixels having a luminance level of a predetermined value or higher to pixels having a luminance level lower than the predetermined value is calculated in the calculating the luminance change, and the at least one of the luminous intensities is adjusted if the calculated ratio is not smaller than a predetermined ratio.

16. The video processing method according to claim 13, wherein the at least one of the luminous intensities of the light emitting devices corresponding to colors red (R) and blue (B) among the plurality of light emitting devices is adjusted in the adjusting the at least one of the luminous intensities.

17. The video processing method according to claim 16, wherein the at least one of the luminous intensities is adjusted based on a look-up map corresponding to the colors R and B.

18. The video processing method according to claim 17, wherein the at least one of the luminous intensities is increased by a ratio of a length in which pixels having a luminance level of a predetermined value or higher are continuous, to a size of the motion vector, in the adjusting the at least one of the luminous intensities.

19. The video processing method according to claim 11, wherein the video displayed on the display module is a gray-scale-scale video.

20. The video processing method according to claim 11, wherein the display module comprises one of a PDP and a CRT.
